(19) United States
(12) Patent Application Publication
(10) Pub. No.: US 2008/0320081 A1
(43) Pub. Date: Dec. 25, 2008

(54) SERVICE COMPONENTIZATION AND COMPOSITION ARCHITECTURE

(75) Inventors: Jonathan Lawson Shriver-Blake, Seattle, WA (US); Sanjib Biswas, Hyderabad (IN)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/765,021

(22) Filed: Jun. 19, 2007

(51) Int. Cl. G06F 15/16

(52) U.S. Cl. 709/205

(57) ABSTRACT

An architecture for componentizing portions of a collaborative or software as a service (SaaS) environment is provided such that users and/or developers leveraging such environments need not initialize and load the entire environment. Rather services are discovered and selectable so applications can be implemented to utilize a portion of the environment where another portion is not required for the access desired. Similarly, thinner versions of a collaborative or SaaS environments can be implemented to provide easy and efficient access to a portion of the service such that processing power and other burdens are removed from the collaboration or SaaS server and respective clients.

### BACKGROUND

The evolution of computers and networking technologies from high-cost, low performance data processing systems to low cost, high-performance communication, problem solving, and entertainment systems has provided a cost-effective and time saving means to lessen the burden of performing every day tasks such as correspondence, bill paying, shopping, budgeting information and gathering, etc. For example, a computing system interfaced to the Internet, by way of wire or wireless technology, can provide a user with a channel for nearly instantaneous access to a wealth of information from a repository of web sites and servers located around the world. Such a system, as well, allows a user to not only gather information, but also to provide information to disparate sources. As such, online data storing and management has become increasingly popular. This has also led to increasing popularity of collaborative working environments.

For example, collaborative working environments allow remotely located users to share resources and collaborate with respect to the resources. Users can share a document, for example where one user is the source of the document and others can view the document receiving real-time updates from the sharing party. Additionally, the other uses can be granted access to update the document as well. This is an application sharing aspect of a collaborative environment. Other functionalities can also be provided such as audio and/or video conferencing. This facilitates further communication thus enhancing the collaboration. The collaboration can be similar to a meeting and attendee lists can be provided and managed as well. Collaborative work systems typically also require authorization for the disparate clients, for example. Thus, the collaborative work environments can have many pieces making the software a thick application as all of the pieces are loaded when collaboration is desired.

Similarly, software as a service (SaaS) applications are becoming increasingly popular where software can be managed and located remotely allowing users to utilize the software via thin-client. In this regard, the user does not need the thick application running on their system—this can save space and processing power on the client system. Additionally, licensing schemes can be easier implemented as the program requires remote access to a central server to run. Thus, the central server can implement the licensing scheme taking the burden from the application. This can also have many parts, such as a licensing service in addition to the application sharing service. However, licensing may not be desired in all environments, and similarly with regard to the collaborative environment, there can be scenarios where not all services and components are necessary or desired.

### SUMMARY

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

An architecture for componentizing services offered within a collaborative work or software as a service (SaaS) environment is provided where an application or user of the collaborative services can desire to utilize only portions and not all of the services offered. In this regard, the services are componentized or modularized and exposed out of the collaborative platform for selective use. It is to be appreciated that selecting all of the available services is possible and can create a platform implementing substantially all the services available, mitigating the advantages of the described subject matter; however, in many cases not all the functionality available is needed. Moreover, allowing selective access to the services mitigates processing, memory, time and other burdens on both the collaborative platform server and clients accessing the server. Furthermore, communication for the services requires less bandwidth, and in at least the foregoing regards, the subject matter described herein creates an efficient and easy-to-use componentized collaborative and/or SaaS platform.

In one embodiment, the collaborative platform can offer a plurality of services, such as authentication, user management, application sharing, audio/video capabilities, chat, note sharing, and the like. However, a user or client can desire only to share an application with someone in a corporate network. Thus, authentication may not be needed as the person to whom the application is to be shared has already been authenticated by the corporate network. Additionally, many other services, such as those mentioned, may not be needed or desired except for the application sharing service. Therefore, the user or client can choose to utilize only the application sharing service via an interface present within the collaborative work environment, for example. It is to be appreciated that other services can be desired in this regard such as the audio conference capability—the desired services can simply be selected and utilized thereafter. The interface can be a graphical user interface (GUI) and/or an application program interface (API), and the services to be exposed by the interface can be discovered throughout the collaborative work environment. For example, the services can be exposed out of the collaborative platform server based on authentication and/or status (e.g. availability) of the services.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 illustrates a block diagram of an exemplary software as a service (SaaS) system.

FIG. 2 illustrates a block diagram of an exemplary componentized SaaS system.

FIG. 3 illustrates a block diagram of an exemplary collaborative work environment.

FIG. 4 illustrates a block diagram of an exemplary collaborative platform server.

FIG. 5 illustrates a block diagram of an exemplary collaborative platform server serving multiple clients.

FIG. 6 illustrates a block diagram of an exemplary highly-componentized collaborative platform server with multiple clients.

FIG. 7 illustrates an exemplary flow chart for discovering and exposing modularized collaboration services.

FIG. 8 illustrates an exemplary flow chart for accessing a portion of available modularized collaboration services.

FIG. 9 is a schematic block diagram illustrating a suitable operating environment.

FIG. 10 is a schematic block diagram of a sample-computing environment.

### DETAILED DESCRIPTION

An architecture for componentizing services available in a platform and composing the available services in a list is provided where the list can be utilized by a client to leverage a portion of the platform. This offers flexibility to client developers as otherwise thick applications can be broken down into individual services, which can then be consumed by the client. Software as a service (SaaS) and collaboration software (such as a web conferencing service, for example) are examples of such normally thick applications that can be modularized to provide beneficial use of the services therein without initializing the entire architecture. Specifically, these platforms often require a user (or users) to login and initialize a framework before taking advantage of the capabilities provided. This can become burdensome for applications, especially where all pieces are not required. For example, SaaS is often associated with authentication and licensing issues, which are separate from the overall benefit of having a thin-client type usage of the underlying application to which the service relates. Thus, in some instances, it can be desirable to separate out these functionalities (such as in separate components) so that where an application can be used with SaaS without requiring authentication or a license, for example, that piece of the platform need not be initialized.

Similarly, collaboration software often comes loaded with features and services, such as application sharing, audio conference capabilities, note sharing, drawing, video conference, chat, and the like. Additionally, these services are packaged together in a heavy framework that requires initialization and authorization to use the foregoing services. However, there can be instances where not all of the functionalities are required, and indeed, where authentication may not be required (for example, when operating within a corporate network). In this regard, the services can be modularized into components having limited interactions such that an application can be developed to utilize only desired portions of the otherwise thick collaborative application. Furthermore, the services can be populated in a list available to the application to indicate which services are available; also, application program interfaces (APIs) can be provided for the available services as well to instruct the application developer on how to take advantage of the componentized service.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

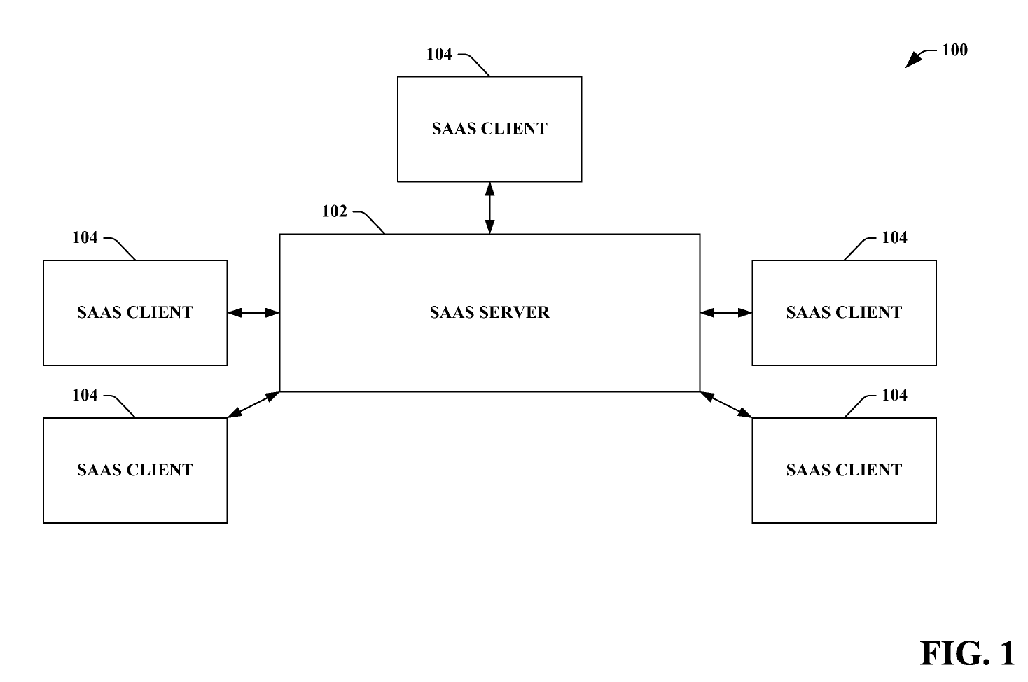

Now turning to the figures, FIG. 1 illustrates a system 100 that facilitates utilizing SaaS. A SaaS server 102 is provided along with a plurality of SaaS clients 104. In one embodiment, the SaaS server 102 provides the thick part of an application and exposes an interface to utilize many aspects of the application, and the SaaS clients 104 comprise a thin-client that can call the methods exposed by the interface to utilize the application. In this regard, software updates are easily managed as only the SaaS server 102 can require updating/patching; additionally, software licensing is also more manageable as the SaaS server 102 can certainly detect how many SaaS clients 104 are connected.

In one embodiment, the services offered by the SaaS server 102 are modularized such that disparate SaaS clients 104 can take advantage of certain parts of the SaaS server 102 without requiring total access. For example, a corporation can create an application that is built on a SaaS type architecture having a SaaS server 102 to expose a plurality of methods utilized to access the application. Additionally, SaaS clients 104 are created to utilize the methods of the SaaS server 102 offering functionality of the application. The company can desire to impose licensing on the application and keep track of such in the SaaS server 102; however, the company can also desire to not impose licensing on some users, such as the internal company. Thus, the SaaS server 102 can be componentized into the licensing service and the thick-client application service. The external SaaS clients 104 can be required to establish a licensing session before using the application, which can also involve some authentication, whereas the internal SaaS clients 104 can bypass the licensing service and be implemented to only utilize the thick-client application service of the SaaS server 102 to operate the application. Thus, in the internal company implementation, the entire architecture need not be loaded (e.g. the licensing service) as it would for external clients (or other clients on which licensing is imposed).

Using this functionality, the SaaS server 102 can expose multiple applications at one time where the applications are modularized in their own components. Thus, not all components need be loaded where only one application is desired, rather the SaaS clients 104 can relate to different applications and only utilize the appropriate portions of the SaaS server 102. Moreover, where authentication and licensing (or other managerial services) are desired, the applications can take advantage of the componentized managerial services provided in the SaaS server 102.

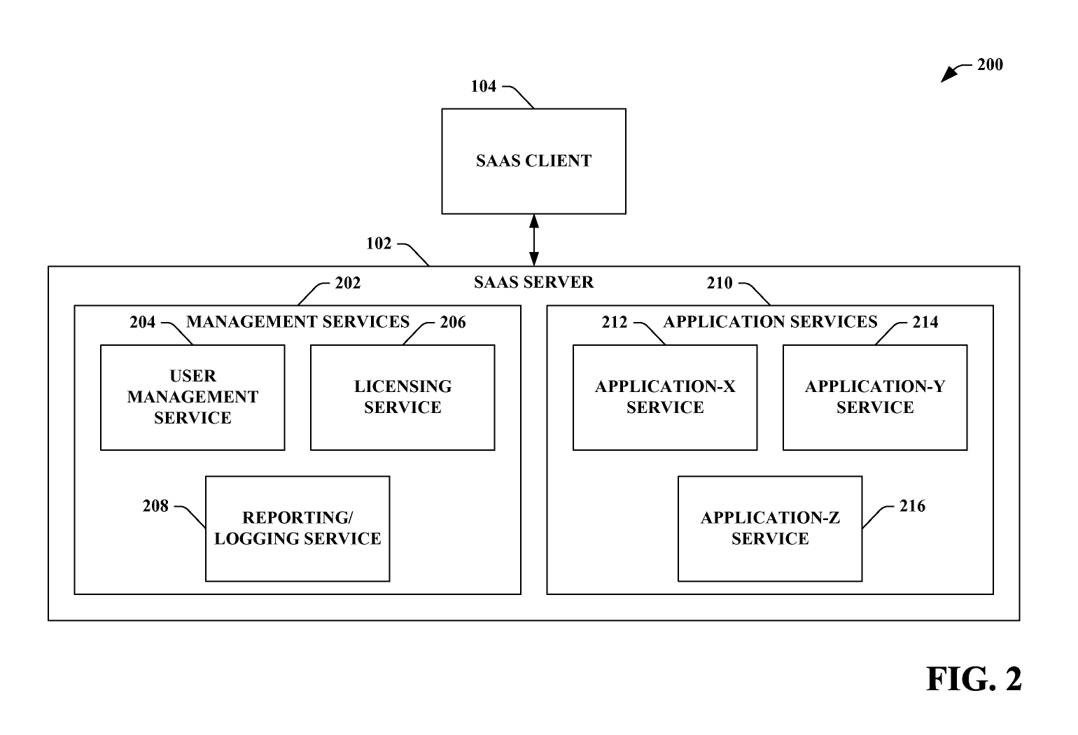

Referring to FIG. 2, an example system 200 that facilitates SaaS functionality is illustrated. A SaaS server 102 is provided with services separated into two modules—management services 202 and application services 210. It is to be appreciated that there can be more services; these are examples of some services common to SaaS. The services are broken down further into user management service 204, licensing service 206, reporting/logging service 208, application-X service 212, application-Y service 214, and application-Z service 216. Also, a SaaS client 104 is provided. The user management service 204 can, for example, handle operations related to users such as account creation, modification/management, and deletion, as well as authentication where desired. The licensing service 206 can provide management for licenses related to the application where one or a group of clients have a limited number of licenses to use the application. The reporting/logging service 208 can provide tracking of activity on one or more instantiations of the application as well as access to the tracking reports/logs. The application services 212, 214, and 216 are thick-client application services for different applications offered by the SaaS server 102.

In one embodiment, the SaaS client 104 can leverage selected services offered by the SaaS server 102. For example, a SaaS client 104 can be created for internal use of application-X; thus only the application-X 212 service need be instantiated by the SaaS client 104. Thus, perhaps user management for the internal implementation is managed by the corporate network credentials; therefore, the user management service 204 is not leveraged by the internal implementation of the SaaS client 104. If other services are desired, such as reporting/logging, the appropriate reporting/logging service 208 can be used by the SaaS client 104 as well to track activity from the client. An additional SaaS client 104 for application-X can be developed for external clients, for example, and require user and licensing management as well; in this case, the appropriate services, the user management service 204 and licensing service 206, are additionally leveraged. In this regard, a plurality of SaaS clients 104 can be developed to meet disparate needs and ease burden on both the clients 104 and the SaaS server 102 as not all of the components are necessarily initialized in every case. Additionally, the SaaS server 102 can also accept additional clients 104 desiring access to the application-Y service 214 and the application-Z service 216; this allows multiple applications to run on the same SaaS server 102 and in some cases leverage common management services.

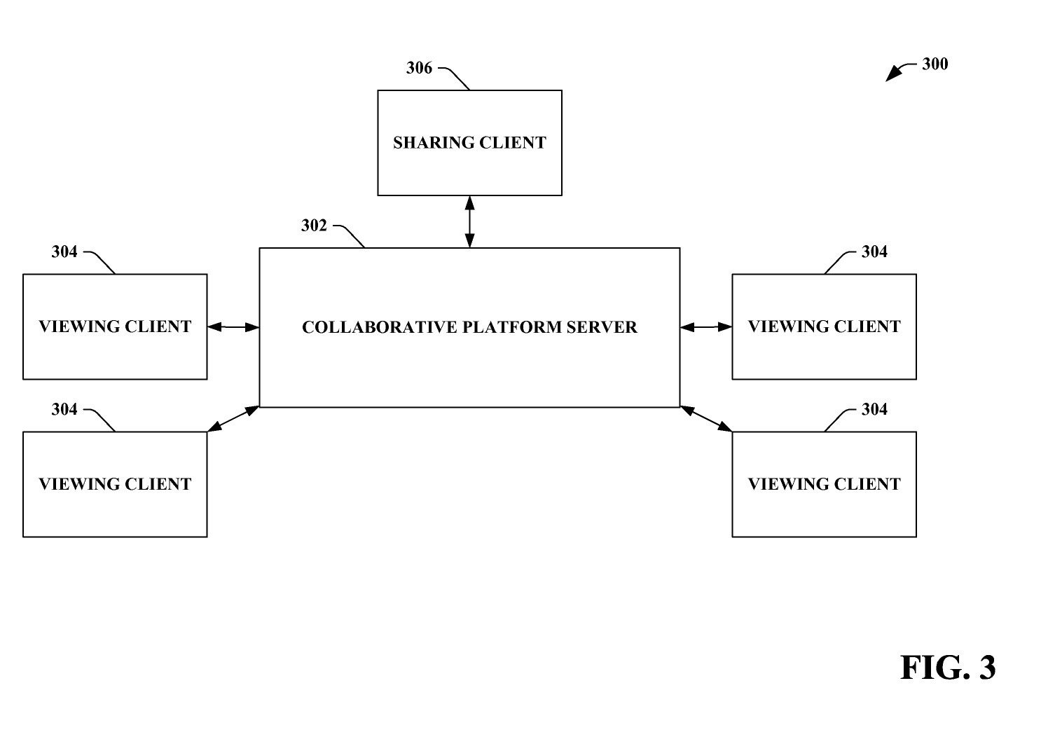

Turning now to FIG. 3, an example system 300 that facilitates collaborative platform communication in accordance with the subject matter herein described is shown. A collaborative platform server 302 is illustrated that provides a central node in the collaboration environment, a sharing client 306 is also provided that desires to share a portion of its system, and a plurality of viewing clients 304 are provided to consume what the collaborative platform server 302 is sharing. It is to be appreciated that a sharing client 304 is not always necessary as the clients can all be viewing clients 304 taking advantage of other services offered by the collaborative platform server 302, such as audio conference. In one embodiment, the sharing client 306 shares an application to the viewing clients 304 via the collaborative platform server 302. In this embodiment, the collaborative platform server 302 acts as a reflector providing viewing clients 304 with real-time updates of the sharing client 306 (and sometimes access to effectuate the updates) with respect to the shared application. The viewing client 304 can be a simple thin-client in this regard relying on the collaborative platform server 302 and the sharing client 306 (and access thereto) for much of the functionality. The viewing client 304 acts as a SaaS client in this way and can be implemented as an ActiveX control, for example.

The collaborative platform server 302 can offer a variety of functionality including the ability to share applications, share notes, share drawings, chat, initiate audio and video conferencing, along with other management tasks such as logging/reporting, authentication/authorization, and user management to name a few. The foregoing functionalities can be implemented as separate component modules within the collaborative platform server 302. In this regard, only services that are desired need be initialized and not the entire collaboration architecture (unless all services are desired). To this end, meetings can be instantiated by utilizing only the video and audio conferencing capabilities if no other services are needed/desired. Similar to the SaaS examples, this relieves burden on the collaborative platform server 302 as well as sharing clients 306 and viewing clients 304 as only the services desired are loaded.

Moreover, a simple application share can decide to utilize only an application sharing service offered by the collaborative platform server 302 and relevant to that application. In this case, perhaps all relevant viewing clients 304 and the sharing client 306 are participating in a closed network such that authorization is implied by virtue of the network communication; thus, user authentication services are not required and should not be loaded. For example, a user can desire to share an e-mail to review with coworkers before submitting the e-mail to its destination. In a system without collaboration, the e-mail would need to be sent to each reviewing party (they would have different copies) and changes merged following review. The collaborative platform allows the reviewers and author to operate on the same e-mail message. In this embodiment, the sharing client 306 is the author of the e-mail and the viewing clients 304 are the reviewers; it is to be appreciated that the reviewers can have access to modify the e-mail as well. Since the parties are likely operating in a corporate network, authentication services are not necessarily needed and neither are most of the other services offered by the collaborative platform server 302 except for an application sharing and/or extension service related to the e-mail client. Since the collaboration platform is lightweight in this regard, the mechanism used to share the e-mail with the reviewers can be as simple as a button or hot-key within the e-mail client. Similarly, the notification to the reviewers that the review session is requested can be just as simple (such as an alert on the screen) since no logins are needed in this embodiment. This saves time and takes unnecessary processing burden off the collaborative platform server 302. It is to be appreciated that authentication can be desired despite the closed-network architecture and in this regard, the developer can simply choose to use an authentication service that can be provided. To this end, separate client applications can be developed for all services in the collaborative platform server 302. Additionally, the services can be exposed to the applications as web services such to self-describe how the applications can use the services.

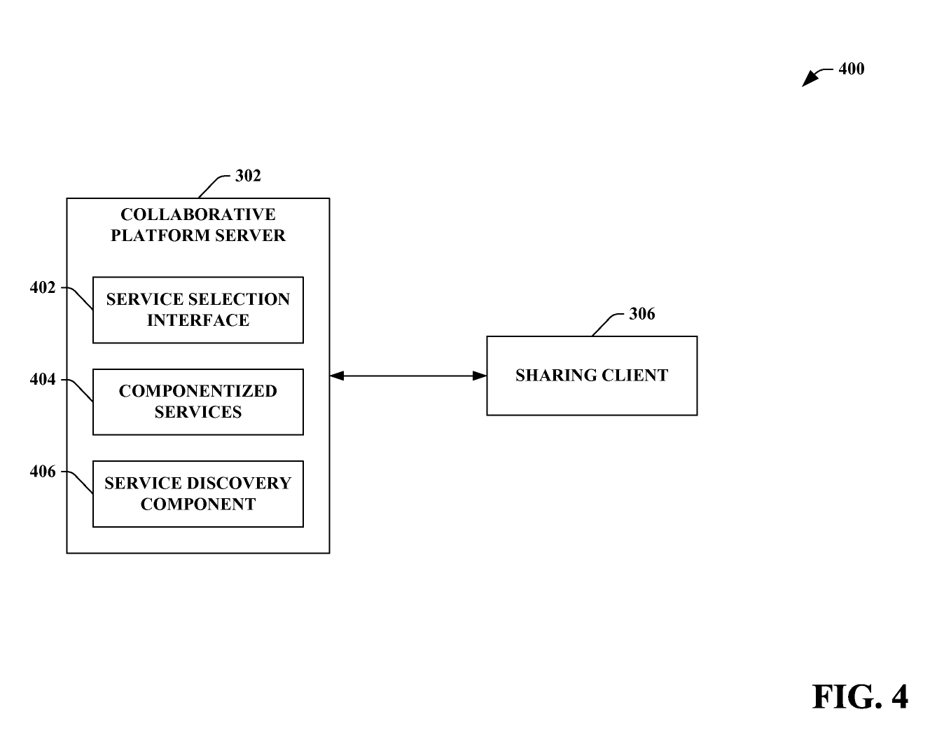

Turning now to FIG. 4, an example system 400 for facilitating choosing services available within a collaboration space is illustrated. A collaborative platform server 302 is provided having a service selection interface 402, a service discovery component, and one or a plurality of componentized services 404. Additionally, a sharing client 306 is shown that can leverage the componentized service(s). In one embodiment, the service discovery component 406 discovers services available within the collaborative platform server 302 and populates the service selection interface 402 accordingly. Subsequently, the sharing client 306 can utilize the service selection interface 402 to request one or more of the componentized service(s) 404. By obtaining this service, applications can be developed to operate in the collaborative environment by utilizing the service(s). Additionally, the services can be utilized to create a customized collaboration environment.

The service discovery component 406 can be used in this embodiment to discover services available within the collaborative platform server 302 in a just-in-time manner, such that services are discovered in real-time upon request, for example. Services can be discovered first based on the services implemented in the system and a list can be populated to the service selection interface 402; additionally, the list can be refined according to other factors, such as for example authorization of the sharing client 306 to services provided and a status of the services in the platform server 302. For example, an application can request a service and if authorization is provided, the service can be excluded from the list and the application denied access to the service based on the user logged in to the application. Additionally, if a service is down for some reason, such as system failure for example, the service can be excluded from the list of those available. In one embodiment, the services can be discovered via universal resource locators (URLs) associated with the disparate services. Where a URL redirects to find the service, this can be handled by the service discovery component 406 and the final URL is displayed or otherwise provided by the service selection interface 402. The list of URLs can also associate a status of the service related to availability (such as active, under maintenance, busy, and the like), and/or business status (such as available, suspended, not licensed, etc.). Moreover, the list can utilize methods to receive URLs according to a specific account and application-domain, but also per specific conference center, for example. Once the list is created and exposed, the sharing client 306 can leverage the available services.

Thus, the service selection interface 402 can be a graphical user interface (GUI) that displays a list of services, for example. The GUI can allow a user seeking to create a collaborative environment, such as the sharing client 306, to choose one or more services from the list. Thus, the user can choose, for example, whether they want to share an application, share an e-mail, initiate an audio and/or video conference, chat, require authentication, etc., and/or any combination thereof. Therefore, the user can easily create a customized collaborative environment without requiring initialization of an entire collaborative software package. As described, this takes substantial burden on time and processing power from the user (sharing client 306, for example), any viewing clients, and the collaborative platform server 302.

In another embodiment, the service selection interface 402 can be an application program interface (API) that allows a developer to leverage one or more of the service(s) available within the componentized services 404 of the collaborative platform server 302 in developing an application. For example, the developer can desire to create an application that packages different services offered by the collaborative platform server 302, such as a thinner collaboration application. Additionally, a wide array of applications can be developed by leveraging the available service without requiring an entire collaboration platform. Additionally, developers can leverage some services while custom coding others where additional functionality or verbosity is needed, for example. Moreover, in one embodiment, applications can create services and expose them out as being available to the collaboration platform server 302. For example, an application can create a specialized service not offered by the collaboration platform server 302, such as note sharing that utilizes proprietary corporation notes, and expose the service as one available in the platform server 302. Subsequently, sharing clients 306 can desire to access the service via API or GUI as described above. This is one way in which custom collaboration applications can be developed in accordance with the subject matter described; additional embodiments will be described as well. Once the services are selected, the sharing client 306 can load the services and be responsible for details regarding displaying the component to the user, such as window size, location, and the like. Additionally, viewing clients can be implemented as a thin-client application to facilitate collaboration by allowing the viewing client access to the sharing client 306—the access can be read-only and/or limited to full updating, for example. It is to be appreciated that the access of the viewing client can change in real-time if access to modify the sharing client 306 is authorized/not authorized, for example. Moreover, the viewing client application can be provided by link on the service selection interface 402, for example, such that the viewing clients can access the interface 402 of the platform server 302 to download appropriate viewing code.

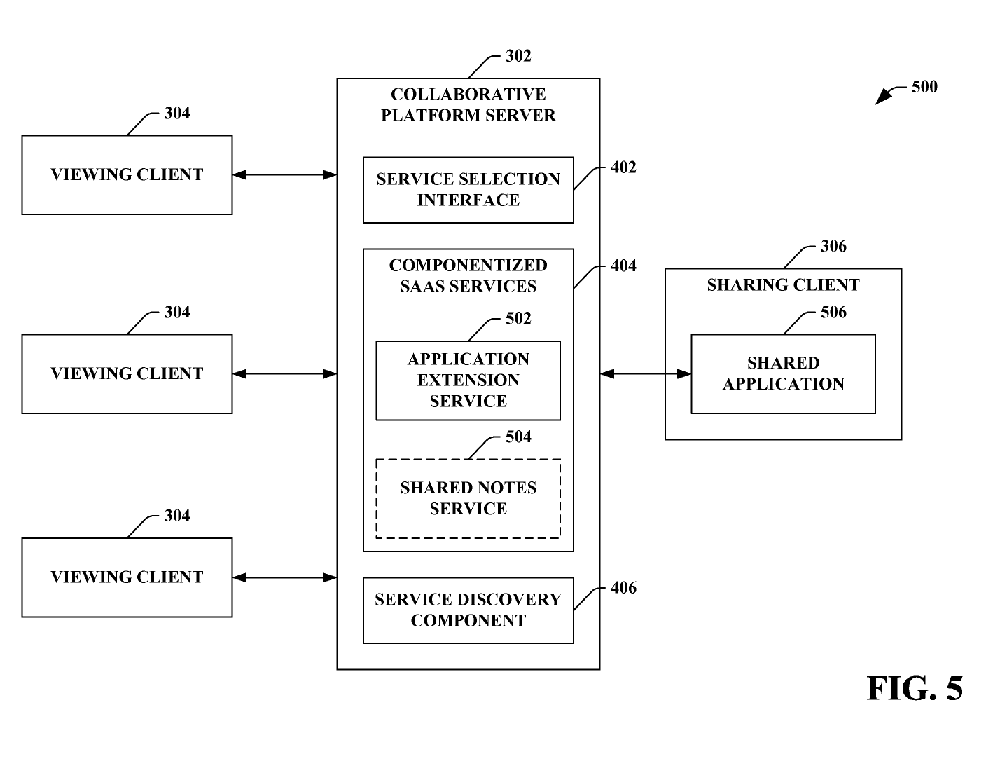

Referring now to FIG. 5, a example system 500 for collaborating selected services is illustrated. A collaborative platform server 302 is provided for sharing an application amongst one or more clients to facilitate collaborative work effort, the application exists on one client machine and can be viewed and updated by the collaboration of clients. The collaborative platform server 302 comprises a service selection interface 402, one or a plurality of componentized services 404, and a service discovery component 406 that discovers the componentized services available. In this embodiment, the componentized services offered comprise an application extension service 502 and a shared notes service 504. In other collaboration environments, these services can be implemented such that both must be initialized and loaded just to use one of them. A sharing client 306 is also provided that is running a sharing application 506, and a plurality of viewing clients 304 can be collaborating to view the shared application 506 in concert.

In one embodiment, as described above the service selection interface 402 can be a GUI displaying the services as selectable to initialize a selective collaboration environment such that application sharing can be provided through the application extension service 502 for a given application without having to initialize or expose the shared notes service 504. The services displayed are those discovered by the service discovery component 406. In one embodiment, the service selection interface 402 can be an API, as described above. In this embodiment, for example, the application 506 can be an enterprise application written to share word-processing documents where intense security measures need be taken because the documents are highly-sensitive. In this regard, the developer can implement the enterprise application with specialized authentication, but utilize the service for sharing documents of the word processing program offered as one of the componentized services 404 in the collaborative platform server 302. Thus, a custom program is created having its own authentication and using the application sharing service offered by the collaborative platform server 302. This architecture is highly flexible in this regard, offering a variety of optional services that are componentized and separately leveraged. Additionally, the componentized services 404 can be implemented as web services, for example, where the web service can be on the platform server 302 and/or the sharing application 306. Thus, the web service can provide viewing clients with access into the shared application 506 via the web services, for example. The viewing clients 304, then, can be implemented as a very thin layer that utilizes the web service to access the services implemented by the shared application, similar to a SaaS implementation. The viewing clients 304 can be implemented as ActiveX control.

For example, the sharing client 306 can be running an instance of the enterprise application 506 and can desire to share a document to a plurality of users (such as the plurality of viewing clients 304) through the enterprise application. A web service for the application extension service 502 within the componentized services 404 can be loaded on the sharing client 306. The web service can provide the collaborative platform server 302 with access to the web services to act as a reflector in processing requests to the sharing client 306 on behalf of one or a plurality of viewing clients. The enterprise application can implement its specialized authentication for the disparate clients, and in this regard, the various clients (sharing and viewing alike) can be required to pass strict authentication to access the enterprise application. For example, once the sharing client 306 has been authenticated within the enterprise application, it can share the application 506 by exposing the web service to the collaborative platform server 302, as described. Once a viewing client 304 has established authentication with the enterprise application, the collaborative platform server 302 can perform requests to the application 506 on the sharing client 306 on behalf of the viewing client. It is to be appreciated that the sharing client 306 can also specify a list of viewing clients 304 that have access, and access can be denied if the viewing client 304 is not on the list. Thus, once the clients are authenticated on the system, the collaborative platform server 302 allows the clients to share the desired application 506 without requiring initialization of any other services, such as the shared notes service 504 if not desired. It is to be appreciated that other services (such as logging/reporting) can be desired and utilized by the enterprise application as well if they exist within the componentized services 404 and are available through the service selection interface 404. Additionally, to this end, the platform server 302 can implement and provide multiple types of one service—for example, multiple authentication services can be implemented to allow the developer utilizing the service to balance a level of authorization with the overhead of utilizing the authorization. For example, a developer can choose a simple authorization service where some authorization is desired but heavy security is not required; on the other hand, the user can choose complex authorization which can also be offered by the collaborative platform server 302 as a service.

In another embodiment, a generic application service can be provided to allow sharing applications 506 to be developed with collaboration functionality. For example, an application can be developed for which there is no service offered by the collaborative platform server 302, however, an API or package of APIs can be provided (from the collaborative platform server 302, for example) for utilization of a generic application sharing service offered by the collaborative platform server 302. The service can provide a set of generic routines to be implemented by the application, for example, and the application can implement the appropriate routines, which can be subsequently packaged in a web service, for example. In this regard, the APIs can be local to the application and can handle communication between the application and the collaborative platform server 302 such that the developer of the application need not have knowledge of this communication. The web service can then be uploaded to the collaborative platform server 302, discovered by the service discovery component 406, and the new application utilizing the generic service can be exposed as an available service from the collaborative platform server 302 as well for use by subsequent sharing clients 306, for example.

A viewing client for the generic application can be written as well to provide for viewing functionality with respect to the sharing application 506 by utilizing a thin client application to make calls to the web service (which can be reflected through the collaborative platform server 302, for example). Additionally, a generic viewing client can be implemented for the totality of applications utilizing the generic application sharing service. To this end, the routines provided by the service to be implemented by the application can be extremely generic and broad such that the set is extendable to a substantial number of possible applications and not just specific functionalities defined by disparate applications. The routines to be implemented can be similar to those required to implement SaaS functionality as well, for example. Thus, in this embodiment, collaboration can be developed with respect to many types of applications. Moreover, the selective nature of the collaborative platform server 302 mitigates the need to initialize all services as described above, thus creating a thin easy-to-use collaboration development platform.

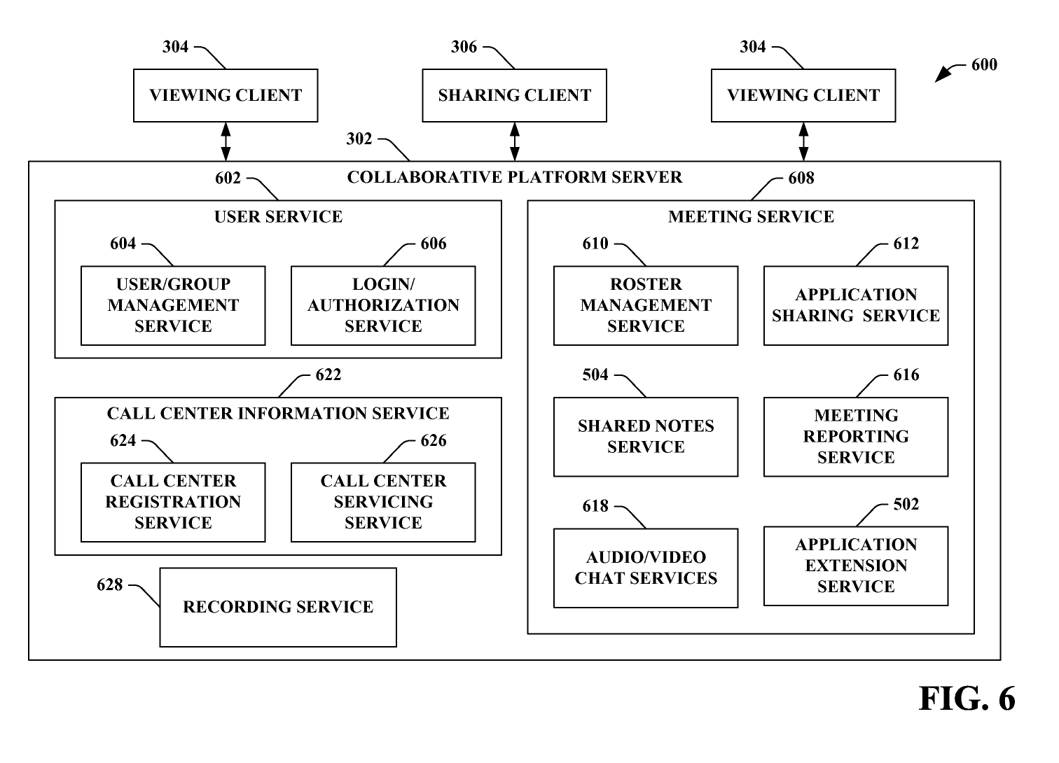

FIG. 6 displays an example system 600 that facilitates componentizing services in a collaboration environment. This is just one example of how services can be componentized and it is to be appreciated that many other implementations are possible in accordance with the described subject matter. Furthermore, the enumerated services are an example list and many other services and/or combination(s) of services can be implemented in this regard. In this example, a collaborative platform server 302 is provided comprising a plurality of componentized services logically grouped with similar services. It is to be appreciated that multiple levels of grouping need not be implemented, or even more granular grouping can be implemented both in accordance with the described subject matter. The groups comprise a user service 602 that handles management of the users in the platform as well as authentication, a meeting service 608 that facilitates functionality with substantially all activities directly related to specific meetings, a call center information service 622 that can be utilized for activities related to a call center that can be common to all meetings in the call center, and a recording service 628 that can record meeting activities in many formats, including voice, video, and commands. Additionally, a sharing client 306 is provided that shares an application or other collaborative service offered with one or a plurality of viewing clients 304.

In one embodiment, the sharing client 306 can utilize a service selection interface (such as those shown in previous figures to be an API or GUI) to leverage one or more of the services offered. It is to be appreciated that the selection service interface can present the services individually and/or in the groups shown in the example 600. The user service 602 can provide a number of services related to user management such as a user/group management service 604 for adding, deleting, or modifying one or more users or groups of users of the collaborative platform server 302. In one embodiment, user management is not needed where simple application sharing within a corporate network (where authentication and user management is already provided), for example. In addition, a login/authorization service 606 can be provided to utilize the authorization/authentication provided in the collaborative environment. Similarly, this may not be needed in every case; thus, providing the modular service facilitates collaboration without this service if desired. Moreover, as described, applications can desire different authentication and can provide their own methods while still utilizing other services offered by the collaborative platform server 302.

Additionally, the meeting service 608 can provide services such as a roster management service 610 that can keep track of users participating in the collaboration session. Again, this service may not be desired in all cases, such as for example where an e-mail is shared between two colleagues. Application sharing services 612 can be provided as well. This can be grouped as one service or separate services for given applications. Moreover, a generic application service can be provided as well. A shared notes service 504, audio/video chat service 618, and an application extension service 502 can also be provided to facilitate the respective portions of a collaborative work environment. The application extension service 502, as shown above, can provide many applications with collaborative functionality by allowing the applications to be developed according to services provided. Additionally, the application extension service 502 can provide sharing of a core set of applications predefined by the collaborative platform server 302, for example. All, some, or none of these can be desired in a given collaborative environment. As described, these service can be offered separately as shown or in a package for all meeting services 608.

Additionally, a call center information service 622 provide services for registering a call center 624 and/or servicing a call center 626. In a corporate network collaboration environment, this functionality may not be needed and does not have to be used; this can be different in other collaboration environments that currently exist. Moreover, some corporations may require call center service 622, for example if the corporation is large and many collaborative spaces/environments are desired to reduce confusion in the large network. If needed, the call center registration service 624 can provide for creating and removing call centers for a collaboration environment. Additionally, the call center servicing service 626 can provide routines for managing existing call centers and facilitating remote access to diagnose call center issues. Also, a reporting service 628 can be provided for system logging, for example. Likewise, this may not be desired in all implementations, for example where an enterprise application is developed that would like to utilize application extension sharing functionality offered in the collaborative platform server 302, but would like to utilize its own internal logging and reporting schemes. Additionally, smaller applications such as that used to share an e-mail between two people may wish to skip this service as well. Thus, the subject matter allows the user to specify desired services with a significant level of granularity such to mitigate loading, initializing, or otherwise having to deal with services that are not desired as is required in typical collaboration software.

The aforementioned systems, architectures and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components can be combined into a single component to provide aggregate functionality. Communication between systems, components and/or sub-components can be accomplished in accordance with either a push and/or pull model. The components can also interact with one or more other components not specifically described herein for the sake of brevity, but known by those of skill in the art.

Furthermore, as will be appreciated, various portions of the disclosed systems and methods can include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent, for instance by inferring actions based on contextual information. By way of example and not limitation, such mechanism can be employed with respect to generation of materialized views and the like.

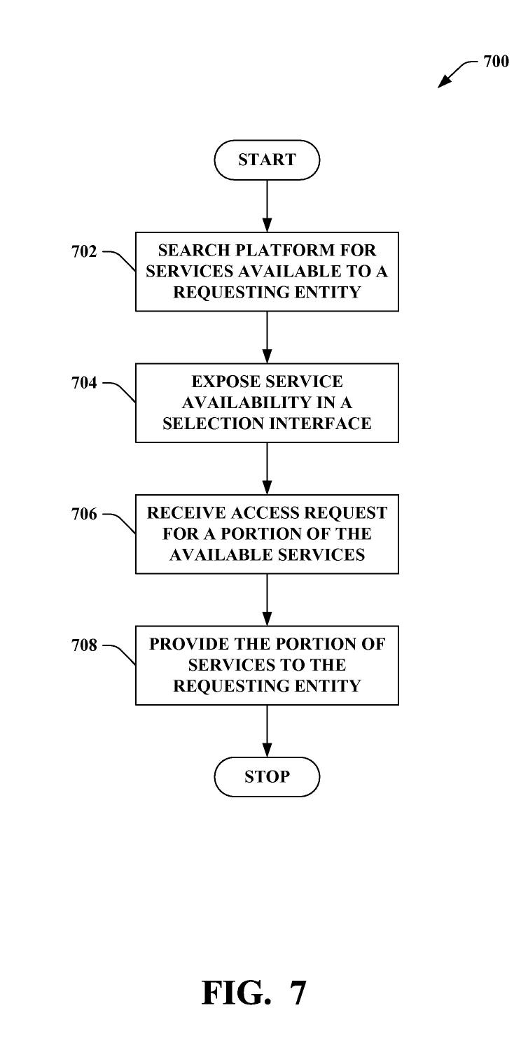

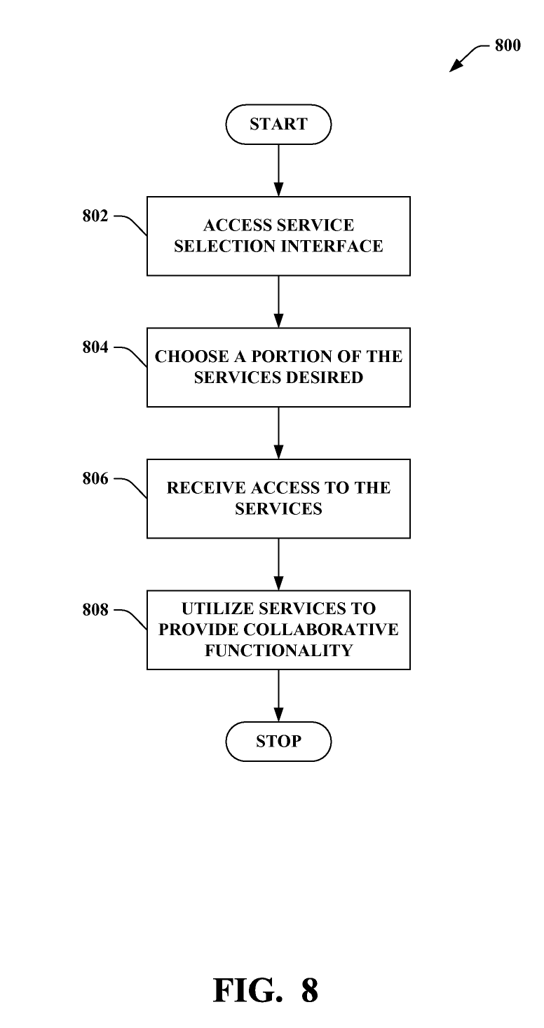

In view of the exemplary systems described supra, methodologies that can be implemented in accordance with the disclosed subject matter will be better appreciated with reference to the flow charts of FIGS. 7-8. While for purposes of simplicity of explanation, the methodologies are shown and described as a series of blocks, it is to be understood and appreciated that the claimed subject matter is not limited by the order of the blocks, as some blocks can occur in different orders and/or concurrently with other blocks from what is depicted and described herein. Moreover, not all illustrated blocks may be required to implement the methodologies described hereinafter.

FIG. 7 illustrates a methodology 700 for discovering and exposing one or more services available in a collaboration platform. At 702, the platform is searched for services available to a requesting entity. A list of services available in the platform can be discovered first and refined according to other factors. For example, services that the requesting entity does not have authorization to access can be excluded as well as services that are down. At 704, a selection interface is populated with the available services and can exclude the foregoing. When searching, the services can have an associated URL, which can provide one or more redirects; the redirects can be handled during the service discovery to get the final URL. Additionally, a status of the services can be checked and stored. At 704, the list of services is populated to a selection interface. The interface can include the URL, version, and one or more status indicators as described. The status can relate to physical availability and/or business status (such as licensing and authorization, etc.). The interface can be a GUI and/or API that can be utilized by a disparate entity to request one or more of the available services such that not all portions of the platform need be initialized, for example, where only a portion is desired.

At 706, a request for a portion of the available services is received. The request can effectuate an API call for example and/or return one or more web services that provide access to the requested services. At 708, the requested services are provided to the requesting entity in this regard. The requesting entity can utilize the services to provide collaborative functionality where the requesting entity is an application, for example. The services requested can be leveraged to provide access to one or a plurality of viewing clients. The platform can act as a reflector to provide this functionality such that the sharing client can utilize the web service provided to allow the platform access therein, and viewing clients can utilize the platform to receive access to the collaboration functions of the application.

FIG. 8 depicts a methodology 800 for requesting access to one or more services provided on a platform. At 802, a service selection interface is accessed—the service selection interface displays a list of services in the platform available to the requesting entity. The services are available to the requesting entity in an a la carte style such that the entity can request only the services it wishes to utilize. In this regard unnecessary processing burden and overhead in the platform and the application are mitigated since only a selected portion of services need be initialized to effectuate collaboration functionality. At 804, the application and/or user chooses the services to be accessed. As described supra, the interface can be an API but can also be a GUI where a user can select the collaborative services and quickly setup a collaboration environment. Once the services are selected, access to the services is received at 806, and at 808, the application utilizes the services to provide collaborative functionality. The functionality can be provided as a just-in-time environment where the user selects the services from a GUI and the environment is created and exposed to any other parties with whom collaboration is desired. Additionally, the functionality can be provided in an application that utilizes an API to request, access, initialize, and utilize the services. In this regard, the application can leverage the services to provide the collaborative functionality in connection with the application. As mentioned, the desired services can be implemented as web services sent to the application desiring to implement the collaborative functionality. The web services can pre-define access with the platform such that the application need only implement portions specific to the application. Additionally, viewing clients can be implemented to utilize the platform for SaaS type access to the application shared by a sharing client (which can also be the requesting entity).

As used herein, the terms “component,” “system” and the like are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components can reside within a process and/or thread of execution and a component can be localized on one computer and/or distributed between two or more computers.

The word “exemplary” is used herein to mean serving as an example, instance or illustration. Any aspect or design described herein as “exemplary” is not necessarily to be construed as preferred or advantageous over other aspects or designs. Furthermore, examples are provided solely for purposes of clarity and understanding and are not meant to limit the subject innovation or relevant portion thereof in any manner. It is to be appreciated that a myriad of additional or alternate examples could have been presented, but have been omitted for purposes of brevity.

Furthermore, all or portions of the subject innovation can be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications can be made to this configuration without departing from the scope or spirit of the claimed subject matter.

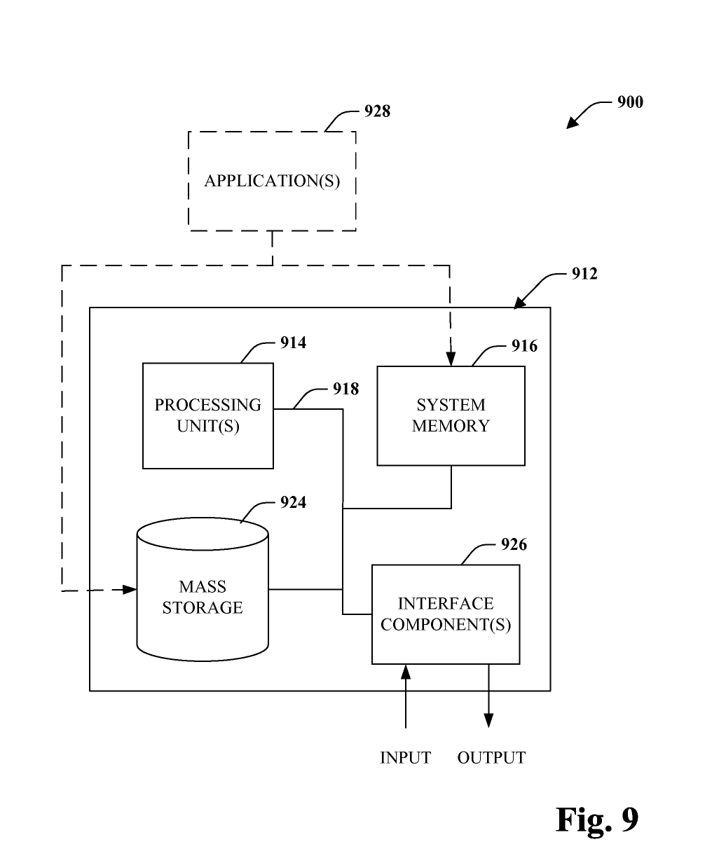

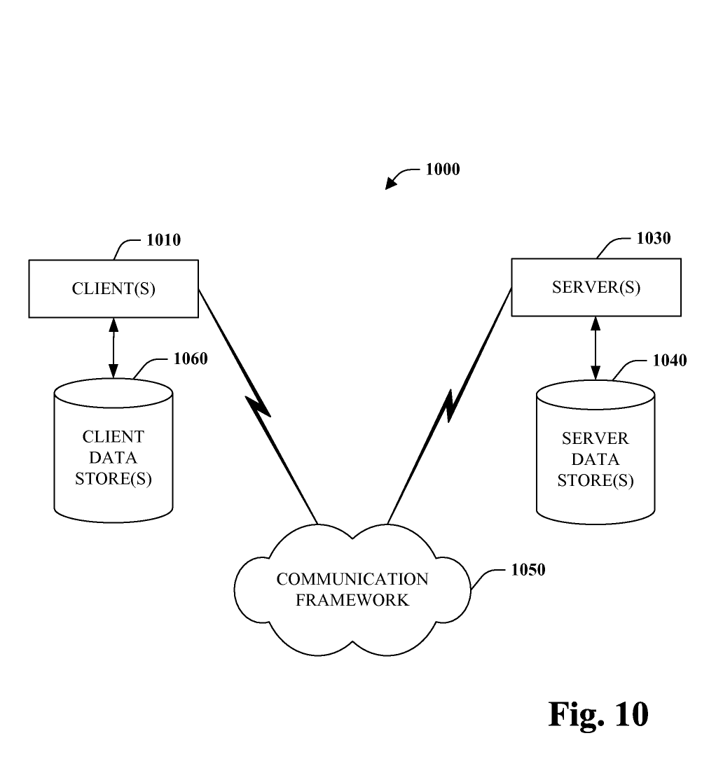

In order to provide a context for the various aspects of the disclosed subject matter, FIGS. 9 and 10 as well as the following discussion are intended to provide a brief, general description of a suitable environment in which the various aspects of the disclosed subject matter can be implemented. While the subject matter has been described above in the general context of computer-executable instructions of a program that runs on one or more computers, those skilled in the art will recognize that the subject innovation also can be implemented in combination with other program modules. Generally, program modules include routines, programs, components, data structures, etc. that perform particular tasks and/or implement particular abstract data types. Moreover, those skilled in the art will appreciate that the systems/methods can be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects can also be practiced in distributed computing environments where tasks are performed by remote processing devices that are linked through a communications network. However, some, if not all aspects of the claimed subject matter can be practiced on stand-alone computers. In a distributed computing environment, program modules can be located in both local and remote memory storage devices.

With reference to FIG. 9, an exemplary environment 900 for implementing various aspects disclosed herein includes a computer 912 (e.g., desktop, laptop, server, hand held, programmable consumer or industrial electronics . . . ). The computer 912 includes a processing unit 914, a system memory 916 and a system bus 918. The system bus 918 couples system components including, but not limited to, the system memory 916 to the processing unit 914. The processing unit 914 can be any of various available microprocessors. It is to be appreciated that dual microprocessors, multi-core and other multiprocessor architectures can be employed as the processing unit 914.

The system memory 916 includes volatile and nonvolatile memory. The basic input/output system (BIOS), containing the basic routines to transfer information between elements within the computer 912, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 912 also includes removable/non-removable, volatile/non-volatile computer storage media. FIG. 9 illustrates, for example, mass storage 924. Mass storage 924 includes, but is not limited to, devices like a magnetic or optical disk drive, floppy disk drive, flash memory or memory stick. In addition, mass storage 924 can include storage media separately or in combination with other storage media.

FIG. 9 provides software application(s) 928 that act as an intermediary between users and/or other computers and the basic computer resources described in suitable operating environment 900. Such software application(s) 928 include one or both of system and application software. System software can include an operating system, which can be stored on mass storage 924, that acts to control and allocate resources of the computer system 912. Application software takes advantage of the management of resources by system software through program modules and data stored on either or both of system memory 916 and mass storage 924.

The computer 912 also includes one or more interface components 926 that are communicatively coupled to the bus 918 and facilitate interaction with the computer 912. By way of example, the interface component 926 can be a port (e.g., serial, parallel, PCMCIA, USB, FireWire . . . ) or an interface card (e.g., sound, video, network . . . ) or the like. The interface component 926 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 912 to output device(s) via interface component 926. Output devices can include displays (e.g., CRT, LCD, plasma . . . ), speakers, printers and other computers, among other things.

FIG. 10 is a schematic block diagram of a sample-computing environment 1000 with which the subject innovation can interact. The system 1000 includes one or more client(s) 1010. The client(s) 1010 can be hardware and/or software (e.g., threads, processes, computing devices). The system 1000 also includes one or more server(s) 1030. Thus, system 1000 can correspond to a two-tier client server model or a multi-tier model (e.g., client, middle tier server, data server), amongst other models. The server(s) 1030 can also be hardware and/or software (e.g., threads, processes, computing devices). The servers 1030 can house threads to perform transformations by employing the aspects of the subject innovation, for example. One possible communication between a client 1010 and a server 1030 can be in the form of a data packet transmitted between two or more computer processes.

The system 1000 includes a communication framework 1050 that can be employed to facilitate communications between the client(s) 1010 and the server(s) 1030. Here, the client(s) 1010 can correspond to program application components and the server(s) 1030 can provide the functionality of the interface and optionally the storage system, as previously described. The client(s) 1010 are operatively connected to one or more client data store(s) 1060 that can be employed to store information local to the client(s) 1010. Similarly, the server(s) 1030 are operatively connected to one or more server data store(s) 1040 that can be employed to store information local to the servers 1030.

By way of example, a sharing client in accordance with the subject matter as described herein can be executed on or as a client 1010. The sharing client can request access to one or more services available within a collaboration platform server, which can be server 1030, over the communication framework 1050. The server(s) 1030 can receive the request and return access to the service to the client 1010. A list of services and/or information relevant to the services can be stored within a data store 1040 or a plurality of data stores. The client(s) 1010 can utilize the selected service to provide collaborative functionality where the client can expose access through the service, and the server 1030 can act as a reflector to provide access to one or more viewing clients 1010.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” or variations in form thereof are used in either the detailed description or the claims, such terms are intended to be inclusive in a manner similar to the term “comprising” as “comprising” is interpreted when employed as a transitional word in a claim.

What is claimed is:

1. A system for developing applications in a collaborative environment, comprising:
a collaborative platform server that provides a plurality of componentized collaboration services; and
an interface that exposes the componentized collaboration services and provides selective access to at least one of the componentized collaboration services to at least one application.

2. The system of claim 1, further comprising a service discovery component that discovers the componentized collaboration services to be exposed.

3. The system of claim 1, the selective access is based at least in part upon an authorization of a requesting entity.

4. The system of claim 1, the interface exposes the componentized collaboration services in a just-in-time manner.

5. The system of claim 1, the componentized collaboration services comprises an application extension service that facilitates sharing an application between a plurality of users.

6. The system of claim 5, the application extension service is a generic service that is utilized by the application to implement collaborative functionalities.

7. The system of claim 6, the application extension service implements a web services interface that corresponds to the application extension service, the platform utilizes the service to fulfill at least one access request from at least one disparate client application.

8. The system of claim 6, the disparate client application operates via the access request as a software as a service (SaaS) client.

9. The system of claim 1, a portion of the componentized collaboration services are utilized without utilizing a disparate portion of the componentized collaboration services.

10. A method for implementing a collaborative work environment, comprising:
creating a plurality of modularized collaboration services;
discovering available collaboration services based at least in part on a status of the service; and
exposing the available collaboration services through an interface, the interface allows selection of at least one service.

11. The method of claim 10, the interface is a graphical user interface (GUI).

12. The method of claim 11, a client application utilizes the GUI to select desired services to implement a portion of a collaborative work environment.

13. The method of claim 10, the interface is an application program interface (API).

14. The method of claim 13, further comprising loading the API on a sharing client, the API comprises a plurality of web services corresponding to services desired by the sharing client.

15. The method of claim 14, the sharing client leverages the web services to implement collaborative functionality within a sharing application.

16. The method of claim 15, further comprising at least one viewing client application that accesses the sharing application via the web services.

17. The method of claim 16, the viewing client application is an ActiveX control executing as a software as a service (SaaS) client.

18. The method of claim 14, discovering available collaboration services is further based at least in part on authorization of the sharing client.

19. A system for creating a collaborative work environment, comprising:
means for discovering a plurality of available modularized collaboration services;
means for exposing the plurality of available modularized collaboration service; and
means for selectively allowing access to the plurality of available modularized collaboration services.

20. The system of claim 19, the selective access based at least in part on access desired by a remote sharing client application.
